(19) United States
(12) Patent Application Publication
(10) Pub. No.: US 2012/0233022 A1
(43) Pub. Date: Sep. 13, 2012

(54) SYSTEM AND COMPUTER IMPLEMENTED METHOD FOR FACILITATING COLLECT ON DELIVERY TRANSACTIONS

(75) Inventors: Lowell Burk, Dallas, TX (US); Gary Corona, Dallas, TX (US); Darren Fishman, Dallas, TX (US); Martin Fishman, Dallas, TX (US)

(73) Assignee: C.O.D. Friendly, Inc., Dallas, TX (US)

(21) Appl. No.: 13/418,042

(22) Filed: Mar. 12, 2012

Related U.S. Application Data
(60) Provisional application No. 61/452,008, filed on Mar. 11, 2011.

(51) Int. Cl. G06Q 30/06

(52) U.S. Cl. 705/26.41

(57) ABSTRACT

A system and computer implemented method for facilitating collect on delivery (COD) transactions may be implemented using specially programmed, general purpose computers connected to a data network. The process may be implemented using an interface provided by the COD provider and accessible to a vendor and customer. A COD payment from the customer it transferred to the COD provider. The COD provider transfers funds to the vendor upon transfer of the payment, then holds the payment for a predetermined amount of time before processing the COD payment. If the customer desires additional time before the payment is processed, they may access the COD provider via an interface and electronically change the COD payment processing date.

### BACKGROUND

1. Technical Field

The present invention relates generally to collect on delivery (COD) processes and, more specifically, to a system and computer implemented method for facilitating COD transactions.

2. Introduction

Conventional collect on delivery (COD) transactions (also known as cash on delivery) generally involve a process wherein a vendor ships goods to a customer, and payment for the goods is tendered from the customer to the deliverer of the goods upon the customer's receipt of the goods. Upon receipt of payment from the customer, the deliverer remits the charge for the goods to the vendor and typically retains a portion of the COD payment as compensation for performing the delivery and COD payment collection. In such transactions, the customer receives the benefit of not having to pay for goods until they are delivered.

### SUMMARY

The present disclosure provides a system for implementing an automated method for processing a payment received upon a customer's receipt of merchandise delivered from a vendor. In general, a COD payment from the customer, for payment of the vendor's goods delivered to the customer, is electronically transferred to the COD provider. Once the electronic COD payment is received by the COD provider, the COD provider transfers funds to the vendor. The COD payment is then held for a predetermined amount of time before being deposited or processed by the COD provider. In the event that the customer desires additional time before the COD payment is processed, the customer may access the interface provided by the COD provider and electronically change the date for which the COD payment is scheduled to be processed. One or more embodiments of the present disclosure may provide one or more of the following advantages: protecting a vendor against a situation in which the customer provides insufficient funding, and offering customers flexible payment terms.

The foregoing and other features and advantages of the present disclosure will become further apparent from the following detailed description of the embodiments, read in conjunction with the accompanying drawings. The detailed description and drawings are of respective example embodiments. The scope of the invention is as defined by the appended claims and equivalents thereof and is not limited to these example embodiments.

### BRIEF DESCRIPTION OF THE DRAWINGS

Embodiments are illustrated by way of example in the accompanying figures, in which like reference numbers indicate similar parts, and in which:

FIGS. 1A and 1B illustrate example embodiments of systems for providing the disclosed computer-implemented method for facilitating a COD transaction;

FIG. 2 illustrates a flowchart describing an example method for facilitating COD transactions in accordance with the present disclosure;

FIG. 3 illustrates an example embodiment of an interface for accessing the COD provider to establish a vendor or customer account;

FIG. 4 illustrates an example embodiment of an invoice;

FIG. 5 illustrates an example embodiment of an interface for accessing the COD provider to scan a check or submit a batch of scanned checks;

FIG. 6 illustrates an example embodiment of an interface showing an image of a scanned check and COD payment data;

FIG. 7 illustrates an example embodiment of an interface for accessing the COD provider to view a batch of scanned checks;

FIGS. 8A and 8B illustrate various example embodiments of interfaces for accessing the COD provider to perform various account managing activities and to request a disbursement of funds, respectively;

FIG. 9 illustrates an example embodiment of an interface for accessing the COD provider to view outstanding COD payments;

FIG. 10 illustrates an example embodiment of an interface for accessing the COD provider to request a line of credit;

FIGS. 11A, 11B, and 11C illustrate various example embodiments of interfaces for accessing the COD provider to add a new debtor;

FIG. 12 illustrates an example embodiment of an interface for accessing the COD provider to view a credit request;

FIG. 13 illustrates an example embodiment of an interface for accessing the COD provider to check the status of funds;

FIG. 14 illustrates an example embodiment of an interface for accessing the COD provider to view whether or not a customer has been approved for a line of credit;

FIGS. 15A and 15B illustrate example embodiments of an interface for accessing the COD provider to view customer balances;

FIG. 16 illustrates an example embodiment of an interface for accessing the COD provider to view additional customer data; and

FIG. 17 illustrates an example embodiment of an interface for accessing the COD provider to view account activity.

### DETAILED DESCRIPTION OF THE DRAWINGS

The present disclosure provides a system and computer implemented method for facilitating collect on delivery (COD) transactions. The COD process described herein may be implemented using one or more specially programmed, general purpose computers connected to a data network. Examples of such networks include, without limitation, the Internet, as well as any other type of private or public data network. Accordingly, the computer implemented steps of the disclosed process may be implemented using one or more interfaces such as, for example, software stored on a computer, applications stored on or accessible via a smart phone or other mobile device, or a website, wherein the one or more interfaces are provided by the COD provider and accessible to at least one of a vendor, customer, or a deliverer of goods from the vendor to the customer (also referred to herein as the carrier).

One or more of the following features may be provided in one or more embodiments of the system or method illustrated in the accompanying figures for facilitating COD transactions: transferring funds to a vendor upon electronic transfer of a COD payment, and providing a customer with an interface for adjusting COD payment terms. As further described below, the transfer of funds to the vendor upon electronic transfer of the COD payment may, in some embodiments, protect the vendor against a situation in which the customer provides insufficient funding. Additionally, providing a customer with an interface for adjusting COD payment terms may, in some embodiments, provide the customer with the ability to generate greater cash flow. Although various embodiments disclosed herein discuss a check as a form of COD payment, it should be appreciated that the term COD payment, as provided herein, is intended to include any form of payment provided from a customer upon the customer's receipt of goods. Accordingly, such forms of payment are not limited to a check and may include, for example, cash, money order, credit card, debit card, gift card, or any other form of payment.

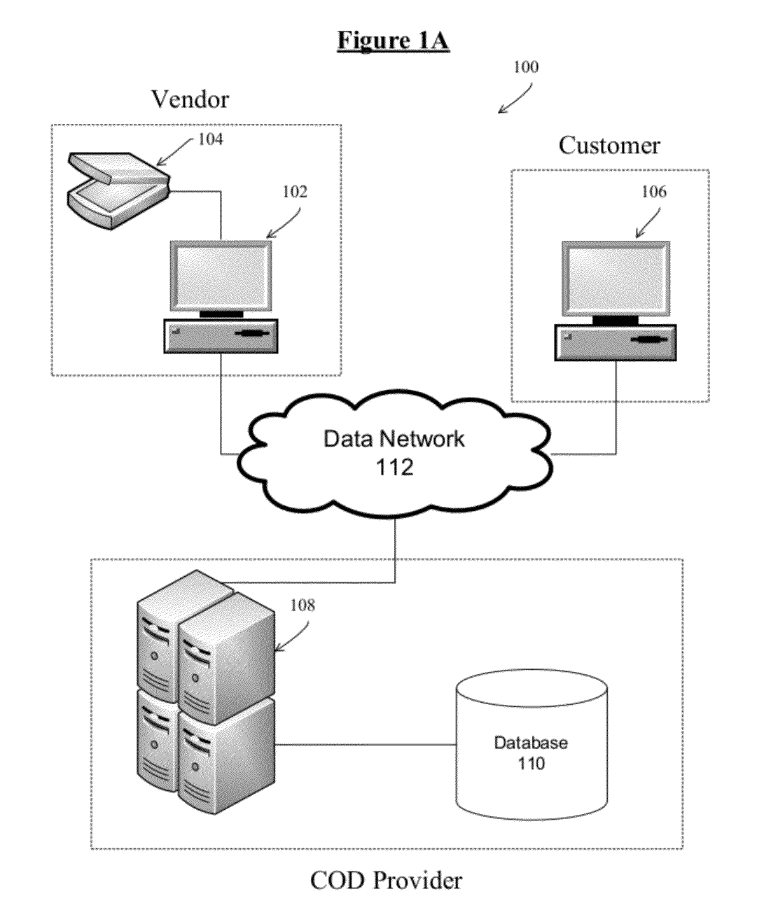

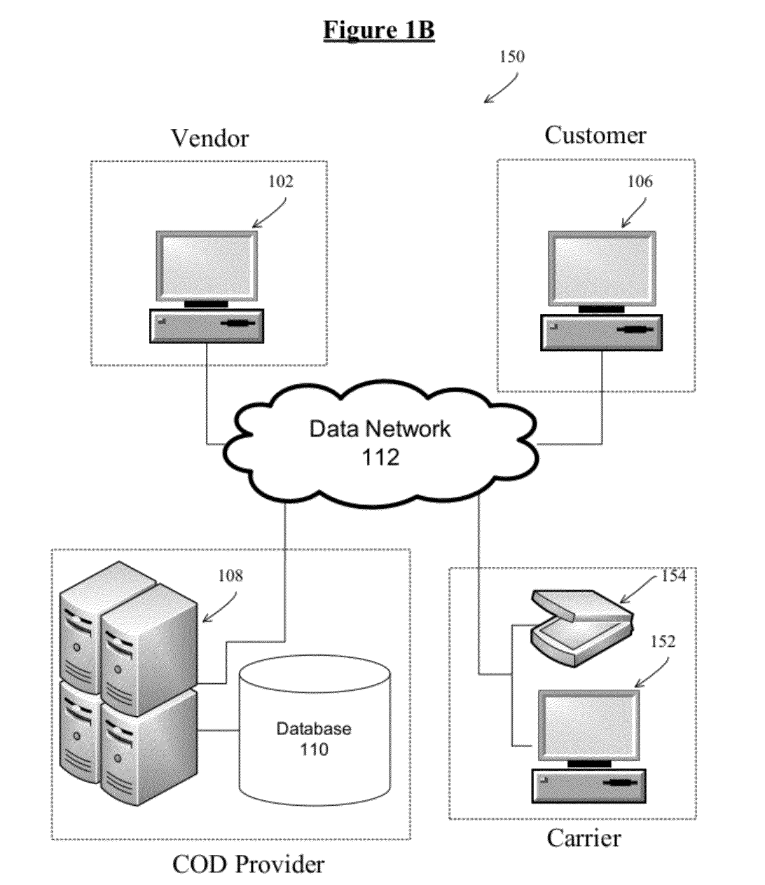

FIGS. 1A and 1B illustrate example embodiments of a system for implementing the disclosed method for facilitating a COD transaction. As shown in FIG. 1A, the system 100 includes a computer 102 or other device operable by a vendor for accessing the COD provider via an interface and a scanning device 104 for generating an electronic version of a COD payment, a computer 106 or other device operable by a customer for accessing the COD provider via an interface, and the COD provider having a server 108 and database 110. As shown in FIG. 1A, the customer, vendor, and COD provider are connected via a data network 112. In accordance with the present disclosure, one or more components of the COD provider generally operate from the server 108 and data is stored in, and retrieved from, the database 110. In some embodiments, the vendor and/or customer may also include a database for local storage of data. Additionally, a scanning device may, in some embodiments, be associated with the customer, the COD provider, or a carrier (as provided below). In such embodiments, the scanning device 104 may or may not be associated with the vendor.

The system 150 shown in FIG. 1B is similar to the system 100 except that the system 150 illustrates an embodiment in which a carrier is operable to access the COD provider via an interface operating on a computer 152 or other electronic device. In one embodiment of the system 150, the carrier may generate an electronic version of the COD payment using a remote scanner 154 and transfer the electronic version of the COD payment over the data network 112 to the COD provider (or vendor) directly from the remote scanner 154 or from the computer 152. Even though it is not shown in FIG. 1B, the carrier may also store the electronic version of the COD payment in a database. Although the systems 100 and 150 show the vendor, customer, and carrier as accessing the COD provider via an interface using a computer, it should be appreciated that the customer, vendor, and carrier may access the COD provider via an interface using other devices including, without limitation, a smart phone, mobile device, remote scanner, or any other data network-accessible device.

Although it is not illustrated in system 100 or system 150 of FIGS. 1A and 1B, in some embodiments, the COD provider may also include one or more computers connected to the server. Also, in some embodiments, the COD provider may include a scanning device in communication with the server 108 directly, or over the data network 112. In such embodiments, the scanning device may be operable to convert a COD payment received from a customer into an electronic format. Such embodiments may allow the COD provider to collect the COD payment directly from the customer, such as, for example, in instances in which the COD provider also acts as the carrier.

In one embodiment, a vendor may invite a prospective or current customer, typically a reseller or retailer of the vendor's goods, to generate an account to participate in the disclosed COD process implemented via a COD process provider (also referred to herein as “the COD provider”). In general, a COD payment from the customer, for payment of the vendor's goods delivered to the customer, is electronically transferred to the COD provider. Once the electronic COD payment is received by the COD provider, the COD provider transfers funds to the vendor. The COD payment is then held for a predetermined amount of time (e.g., 30 days) before being deposited or processed by the COD provider. The hold on the COD payment allows the customer time to sell merchandise before the COD payment is processed, thus freeing up the customer to generate greater cash flow. In some embodiments, the COD process may include processing a request for a credit line for the customer so that the customer can reorder merchandise from the vendor even if the customer lacks available funding. In the event that the customer desires additional time before the COD payment is processed, the customer may access the interface provided by the COD provider (for example, the customer may logon to a website) and electronically change the date for which the COD payment is scheduled to be processed.

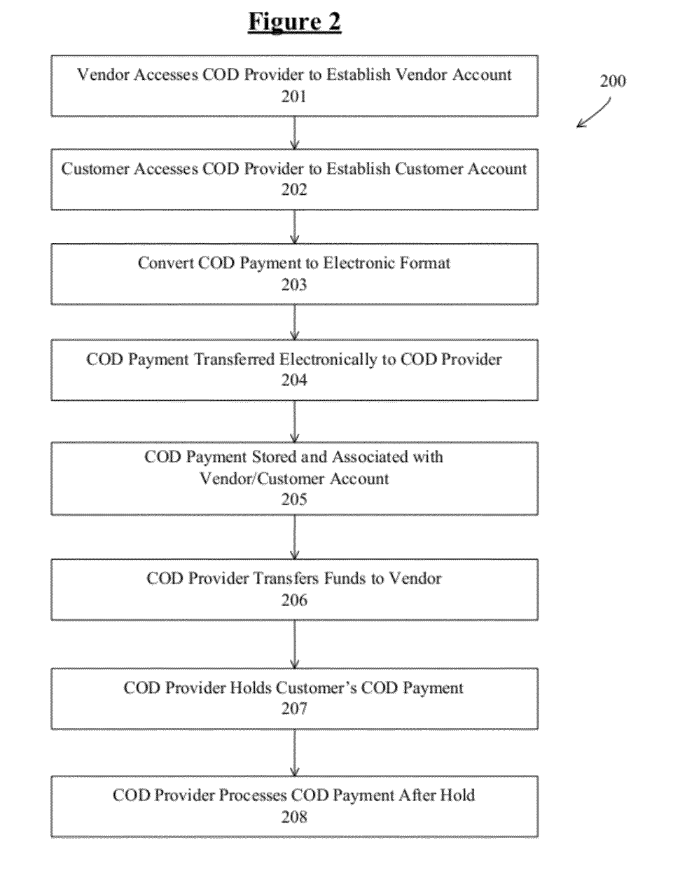

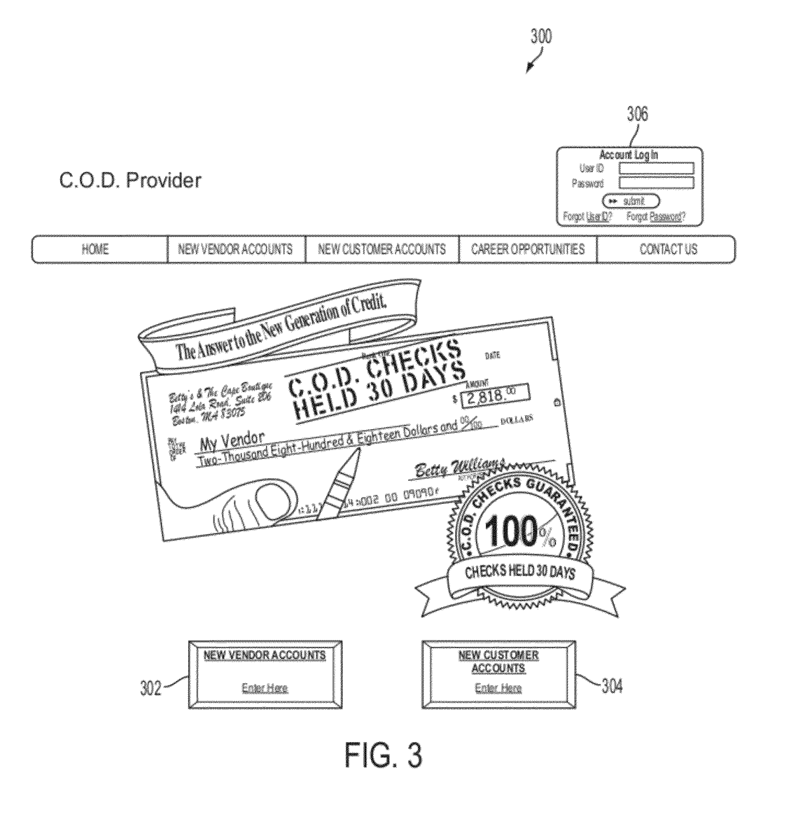

FIG. 2 illustrates a flow chart 200 of the basic steps of an example embodiment of the disclosed COD process, wherein the basic steps provided in FIG. 2 are initially discussed in general and then are described in greater detail below with respect to FIGS. 3-9. In step 201, a vendor accesses the COD provider to establish a vendor account. In step 202, a customer accesses the COD provider to establish a customer account. Once the vendor and customer have established accounts with the COD provider, COD orders may be facilitated using the COD provider. When a COD order for goods or services provided by the vendor is placed by the customer, the COD order is delivered to the customer by the carrier, and a COD payment is collected from the customer. In step 203, the COD payment is converted to an electronic format, and then electronically transferred to the COD provider in step 204. Once the COD payment is received by the COD provider, data obtained from the electronic COD payment is stored in a database of a specially programmed computer and associated with the vendor and/or customer account in step 205. In step 206, the COD provider transfers funds to the vendor. In step 207, the COD provider holds the customer's COD payment for a predetermined amount of time. Once the duration of the hold on the COD payment has expired, the COD payment is then processed by the COD provider in step 208. In some embodiments, step 208 may also include transferring any remaining funds to the vendor upon processing the COD payment.

As mentioned above with respect to step 201 of FIG. 2, a vendor may access the COD provider to establish a vendor account. FIG. 3 illustrates an example embodiment of an interface 300 accessed by the vendor (and provided by the COD provider) to establish a vendor account. In some embodiments, the vendor may access the COD provider via the interface 300 to establish a vendor account by selecting the new vendor account icon 302. The COD provider may then prompt the vendor to provide data about itself, wherein the COD provider receives the vendor data and stores it in a database of a specially programmed computer to establish the vendor account. Such vendor data may include, for example: a corporate name, trade name, tax information, address data, a phone number, a fax number, an email address, a contact name, business type, date of establishment, company website, revenue data, ownership data, company policy data, bank account data, electronic money transfer instructions, and vendor account data.

As shown in FIG. 3, the interface 300 further includes a new customer account icon 304. In accordance with an embodiment of the present disclosure, a customer may access the COD provider using the interface 300 to establish a customer account by selecting the new customer account icon 304. The COD provider may then prompt the customer to provide data about itself, wherein the COD provider receives the customer data and stores it in a database of a specially programmed computer to establish the customer account. Such customer data may include, for example: store data, principal data, credit card data, bank data, and customer account data. The store data may include, for example: a corporate name, a DBA name, tax data, store address data, billing address data, and contact data. The principal data may include, for example: principal name, address data, contact data, and ownership data.

Once a vendor or customer account has been established, the vendor or customer may access the COD provider to view, manage, or otherwise access their account. For example, in one embodiment, the customer or vendor may access the COD provider via the user account login icon 306 of the example interface 300 shown in FIG. 3. Once logged in, the COD provider may provide various interfaces for allowing a vendor or customer to perform various account activities. For example, the COD provider may provide one or more interfaces for allowing a vendor to view their account status, view a list of customers, create invoices, view orders, view open customer balances, request a credit line for a customer, electronically transfer COD payments, manage account funds, and various other activities. Additionally, the COD provider may provide one or more interfaces for allowing a customer to, for example, view orders, view invoices, check the status of a COD payment, request a credit line, change a scheduled deposit date for a COD payment, and various other activities. Some of these various activities are discussed in greater detail below.

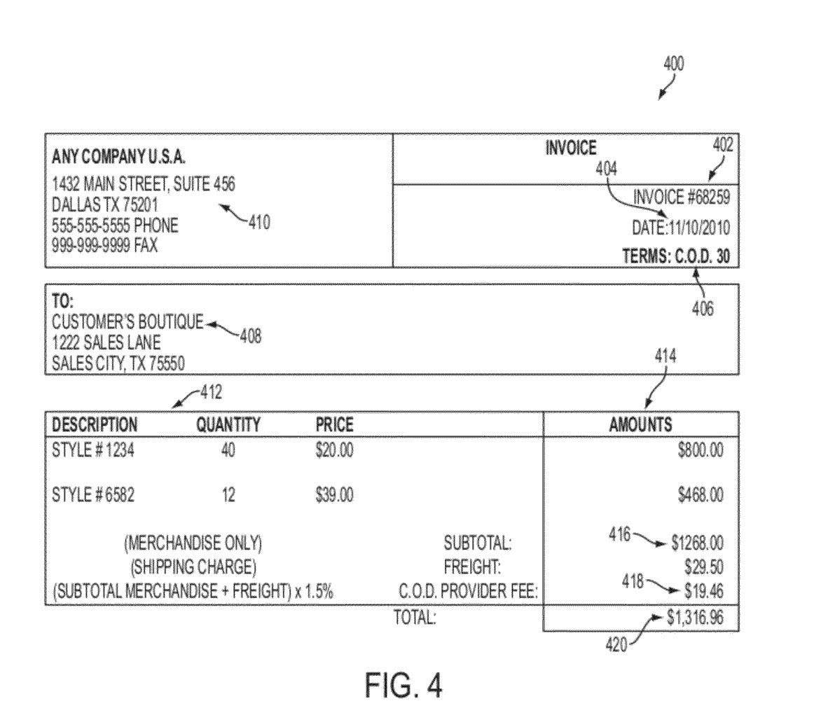

As mentioned above, once the vendor and customer accounts are established, a COD order may be placed with the vendor. In accordance with some embodiments of the present disclosure, once the COD order is placed with the vendor, the COD provider may provide an interface to allow a vendor to prepare an invoice for the COD order. FIG. 4 illustrates an example embodiment of an invoice 400, wherein the invoice 400 includes invoice data such as an invoice number 402, an invoice date 404, a term code 406 indicating the terms of the customer's payment, a shipping address 408, the vendor's information 410, order data 412, and fee data 414. In some embodiment, the invoice may be in an amount equal to a charge 416 for the goods and services plus a fee 418 or interest charge, wherein the fee 418 may be based, for example, on a predetermined percentage rate and period of time for holding the COD payment. The invoice data is stored in a database of a specially programmed computer by the COD provider and is associated with at least one of the vendor account and the customer account involved in the COD transaction. Once the invoice is prepared, the vendor ships the merchandise to the customer with a COD label to collect the amount 420 provided on the invoice 400.

Once the COD order is delivered to the customer, the COD payment is collected from the customer by the carrier. Once the COD payment is collected from the customer, it is converted into an electronic format in step 203. An electronic version of the COD payment may include, for example, a scanned image of the COD payment, and electronic payment data such as, for example, credit card numbers, bank account numbers, routing numbers, security data, credit card expiration dates, check numbers, electronic signatures, or any other data typically associated with various forms of electronic payment. In some embodiments, the conversion of the COD payment to an electronic format may be performed by the carrier. For example, if the COD payment is a check, the carrier may scan the check or the MICR numbers of the check using a remote scanner to generate an electronic version of the COD payment. The carrier may then transfer the electronic version of the COD payment to the vendor, or directly to the COD provider. In other embodiments, the conversion of the COD payment to an electronic format may be performed by the vendor. In such cases, the carrier may collect the COD payment, then send the physical COD payment (e.g., a check) to the vendor. Once the physical COD payment is received from the carrier, the vendor converts the COD payment into an electronic format. Regardless of whether the vendor or carrier performs the electronic conversion, the electronic version of the COD payment may be stored in a database of a specially programmed computer by at least one of the vendor, carrier, or COD provider. It should be appreciated that, in some embodiments, the COD provider may also provide the delivery of the merchandise and collection of the COD payment. Thus, in some embodiments, the carrier may actually be the COD provider or associated with the COD provider.

In step 204, the COD provider may provide an interface for transferring the electronic version of the COD payment to the COD provider. In other words, the COD provider receives, via an interface, the electronic version of the COD payment, in step 204. In some embodiments, a user may access the interface to upload to the COD provider the electronic version of the COD payment generated in step 203 as well as any COD payment data such as, for example, an invoice number, a check number, payment amount, invoice amount, customer data, vendor data, or any other data relative to the COD order/transaction. In some embodiments, step 204 may prompt the user to transfer the electronic version of the COD payment to the COD provider, wherein the user may include, for example, the vendor, carrier, or the customer. In some embodiments in which the carrier transfers the COD payment to the COD provider, the carrier may transfer the COD payment electronically to the COD provider before leaving the package with the customer.

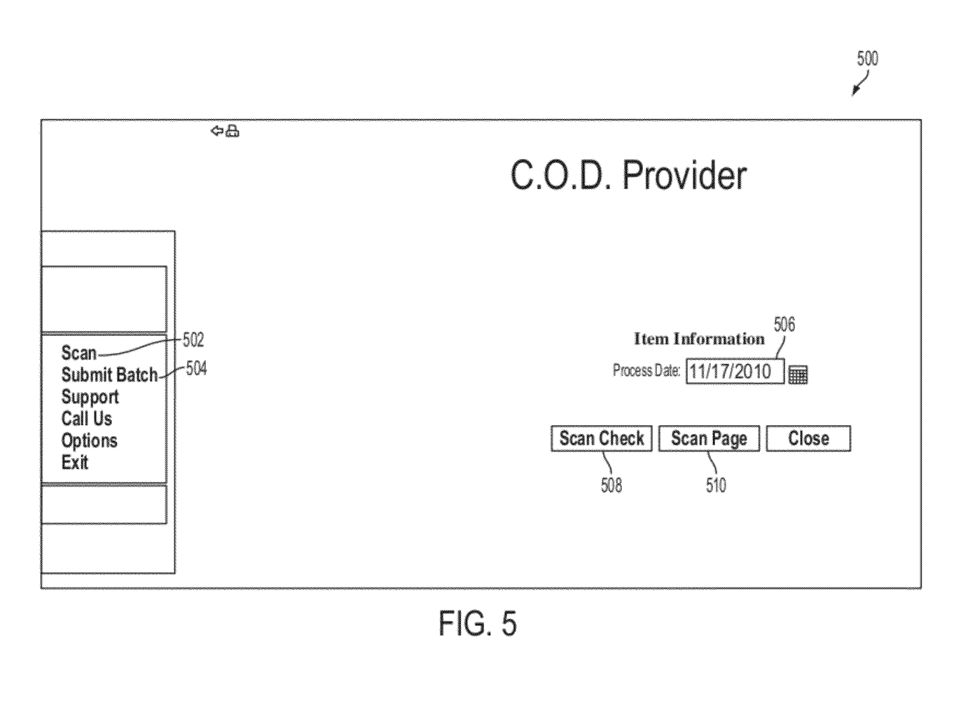

FIGS. 5-7 are provided herein to illustrate various example interfaces provided by the COD provider during steps 203-205 of FIG. 2. Accordingly, FIGS. 5-7 are provided in support of an example embodiment of the present disclosure, wherein a COD payment is converted into an electronic format, the electronic version of the COD payment is transferred to the COD provider, and the COD payment is stored and associated with the vendor and/or customer accounts involved in the COD transaction. In the embodiment illustrated by FIGS. 5-7, the COD payment is in the form of a check drawn on a customer's bank account, and the electronic conversion of the COD payment is performed, at least in part, by a check scanner (not shown) such as, for example, the CheXpress CX30 check scanner provided by Digital Check Corp. In accordance with various embodiments of the present disclosure, the process of converting the COD payment into an electronic format (i.e., step 203 of FIG. 2) may be referred to herein as “scanning a check.” Additionally, the process for transferring the electronic version of the COD payment to the COD provider (i.e., step 204 of FIG. 2) may be referred to herein as “submitting a batch.” Although a check scanner is disclosed herein as the device for converting the COD payment to electronic format, it should be appreciated that the COD payment may be converted to an electronic format in various other ways. For example, a user (e.g., vendor or carrier) may manually enter payment data, take a picture of the COD payment, or scan a card such as, for example, a credit card.

FIG. 5 shows an example interface 500 for accessing the COD provider, wherein the interface 500 may be provided, for example, by a website or software stored on a computer and accessible to the vendor. The interface 500 includes a scan link 502 and a submit batch link 504. When the scan link 502 is selected, the interface 500 shows a process date input 506, a scan check icon 508, a scan page icon 510. In accordance with an embodiment of the present disclosure, when scanning a check, the vendor may be prompted to enter the date in the process date input 506 (if not already provided), then select the scan check icon 508. In accordance with the present embodiment, the vendor then inserts the COD payment (i.e., the check) into the check scanner to scan the check. Once the check is scanned, the COD provider reads the scanned check and extracts COD payment data such as, for example, the routing number, check number, check date, check amount, and an invoice number. The scanned check, as well as the COD payment data, comprise an electronic version of the COD payment. The check reading or data extraction may be performed by a computer program stored on a computer of the COD provider. Once the data is extracted, it is stored in a database of a specially programmed computer by the COD provider.

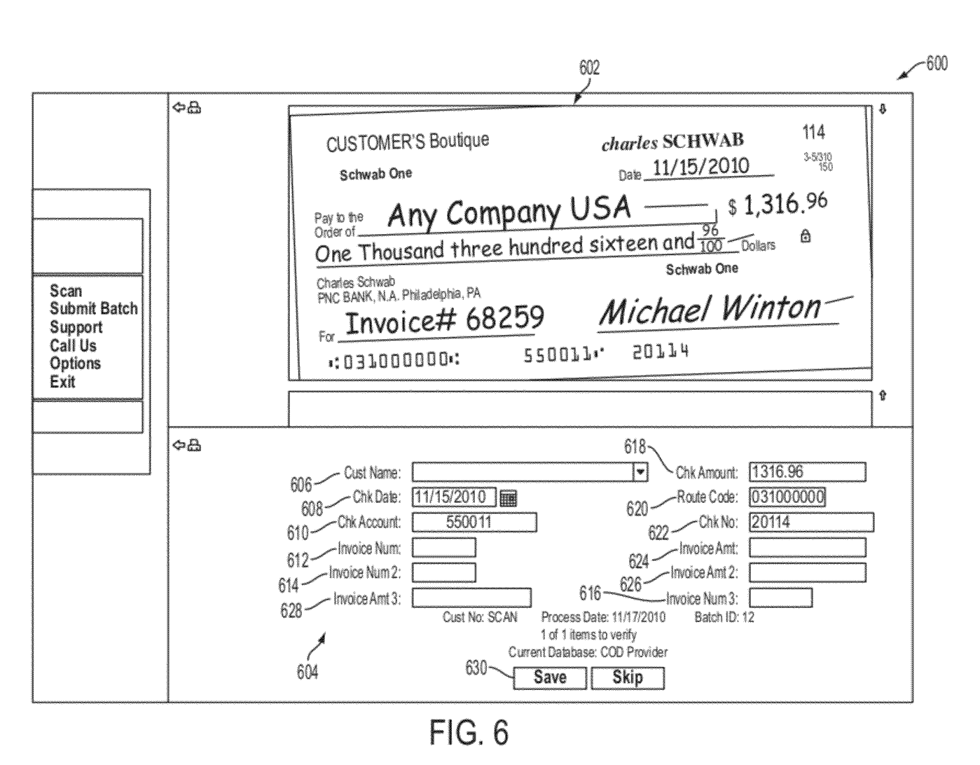

FIG. 6 illustrates an example embodiment of an interface 600 showing an image of the scanned check 602, and various example COD payment data fields 604. As shown in FIG. 6, the COD payment data may include the customer name 606, check date 608, check account number 610, invoice number 612, a second invoice number 614, a third invoice number 616, a check amount 618, the check routing code 620, the check number 622, the invoice amount 624, a second invoice amount 626, and a third invoice amount 628. In the example embodiment shown in FIG. 6, the COD provider extracted the check amount, check date, check account, routing code, and check number COD payment data. Thus, these respective data fields 604 are populated in the interface 600 shown in FIG. 6. If the customer name 606 is not already provided, the vendor may select the customer from a drop-down menu to enter the customer name data 606. Once the COD payment data is provided, the vendor may select the save icon 630. The COD provider then receives the COD payment data and saves it to a database. When the COD payment data is stored to the database, it is associated with the vendor and/or customer accounts involved in the COD transaction. This action is discussed in greater detail below with respect to step 205 of FIG. 2.

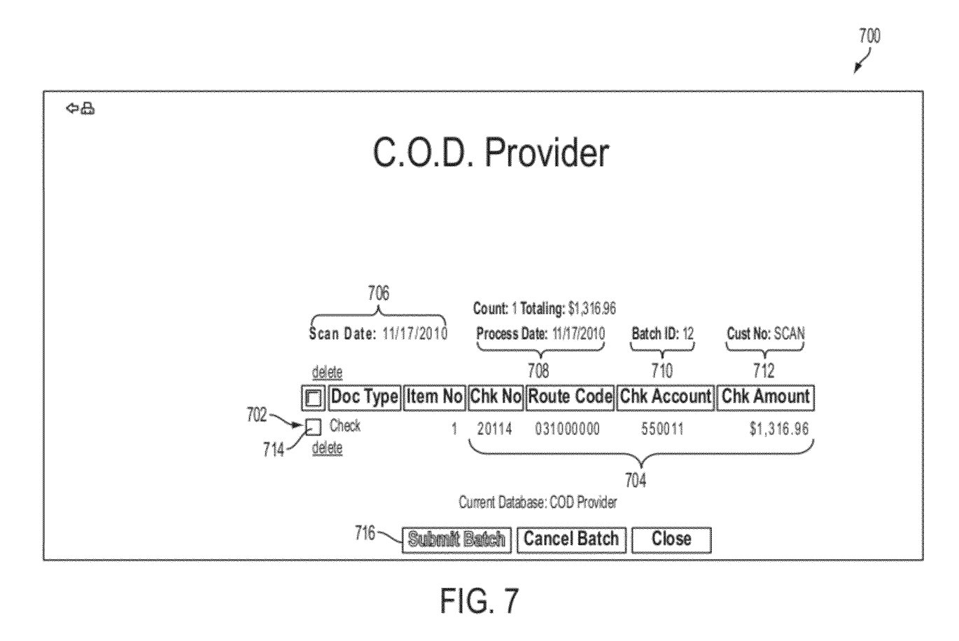

Referring again to the interface 500 provided in FIG. 5, the vendor may select the submit batch link 504 to electronically transfer the electronic version of the COD payment to the COD provider. When the submit batch link 504 is selected, the COD provider presents an interface 700 showing a list of scanned checks. The example interface 700 illustrated in FIG. 7 shows the COD payment 702 (i.e., check) that was scanned as discussed above with respect to FIG. 6. The interface 700 illustrates the COD payment data stored for the respective COD payment 702 as well as additional data generated during the scanning (i.e., electronic conversion) of the COD payment 702. In the embodiment shown in FIG. 7, the additional data includes the scan date 706, process date 708, batch ID 710, and a customer number 712. The vendor may then select the COD payment 702 by selecting a checkbox 714, and then upload the COD payment 702 to the COD provider by selecting the submit batch icon 716. By selecting the submit batch icon 716, the electronic version of the COD payment 702 is then transferred to the COD provider. In some embodiments, the vendor (or carrier) may also send the physical COD payment to the COD provider.

Referring to step 205 of the method provided in FIG. 2, once the electronic version of the COD payment is received by the COD provider, the COD provider stores it in a database of a specially programmed computer and associates it with the vendor and/or customer accounts involved with the COD transaction. It should be appreciated that since the COD payment received by the COD provider is in an electronic format, the COD provider may, in some embodiments, automatically extract COD payment data from the electronic version of the COD payment (as discussed above), store the COD payment data in a database, and associate it with the vendor account and/or customer account. In some embodiments, such as those discussed above with respect to FIGS. 5-7, this may be performed automatically by a computer program operable to analyze the electronic version of the COD payment and extract the COD payment data. For example, if the electronic version of the COD payment is a scanned image of a check, then the computer program may identify the check number, routing number, bank account number, the check amount, the customer name, and the vendor name from the scanned image of the check. The computer program may then store the COD payment data in a database and associate all or some of the payment data with the vendor account and/or customer account. As another example, if the COD payment is a credit card payment, the electronic version of the COD payment may include a scanned image of the credit card, or credit card data provided to the COD provider, as well as any additional data provided by the vendor such as, for example, an invoice number. The COD provider may then extract the credit card number, a security code, the name on the credit card, an expiration date, and any other data provided to the COD provider, store the data in a database, and associate the data with the vendor and/or customer accounts.

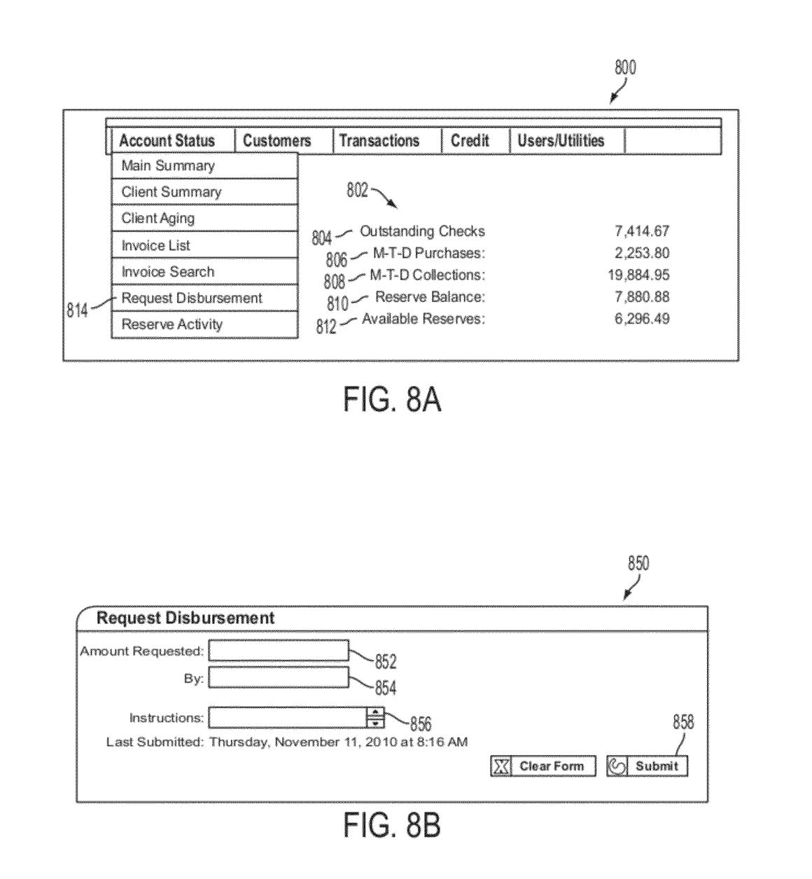

In some embodiments, when the COD provider receives and stores the electronic COD payment (and any COD payment data), the COD provider then transfers funds to the vendor in step 206, prior to depositing or processing the COD payment. The funds transferred to the vendor may be in an amount equal to all, or a predetermined portion, of the invoice amount. In some embodiments, the transfer of funds may be an automated process, wherein a computer program stored on a computer of the COD provider, transfers the funds upon receiving and/or storing the electronic COD payment. In other embodiments, the funds may be transferred by a user accessing the COD provider. In some embodiments, the transfer process may include manually or automatically verifying the COD payment data, account data, and/or any other data associated with the transferring of funds. In some embodiments, the funds may be transferred to the vendor's bank account (e.g., via banking wire transfer) upon receipt of the COD payment, whereas in other embodiments, the funds may be allocated to the vendor's account to be released upon request by the vendor, as described below with reference to FIGS. 8A and 8B. In some embodiments, any remaining balance of the invoice amount may be funded to the vendor upon processing the COD payment after the hold expires.

FIGS. 8A and 8B illustrate example interfaces 800 and 850 (provided by the COD provider) for accessing the COD provider to perform various activities such as, for example, requesting a transfer of funds from the vendor account to the vendor's bank account after transferring a COD payment. As shown in FIG. 8A, the interface 800 provides a summary of the current balances 802 associated with a vendor's account. The balances may include, for example, the balance for outstanding checks 804, month-to-date purchases 806, month-to-date collections 808, a reserve balance 810, and available reserves 812. In accordance with the present embodiment, the available reserves 812 is the amount that is available for release upon request from the vendor. Additionally, the outstanding checks balance 804 is the amount of customers' invoices for which COD payment has not been processed.

The interface 800 may also include a “Request Disbursement” link 814. When a vendor selects the request disbursement link 814, the interface 850 illustrated in FIG. 8B is shown. The vendor may enter an amount requested 852, a date 854 by which the funds are requested, and instructions 856 for transferring the funds. After entering the data in the request disbursement fields, the vendor may complete the request by selecting the submit icon 858. When the disbursement data is received by the COD provider, the COD provider may analyze, via an automated or manual process, the disbursement data to determine approval of the disbursement. Such analysis may include comparing the amount requested to the amount of reserves available. If the request is approved, the COD provider transfers funds to the bank account of the vendor.

In step 207 of FIG. 2, the COD provider holds the COD payment for a predetermined amount of time. In some embodiments, the COD provider offers flexible payment terms for the COD customer by holding the COD payment for a predetermined amount of time such as, for example, 30 days. This delay may allow the customer time to sell the goods before the COD payment is processed, which may, in turn, increase cash flow for the customer. The increased cash flow may allow the customer the ability to reorder products from the vendor even if the customer lacks immediate funding. This may also be beneficial to the vendor because it could allow the vendor to move products off their shipping docks faster, without having to ensure the customer is properly funded.

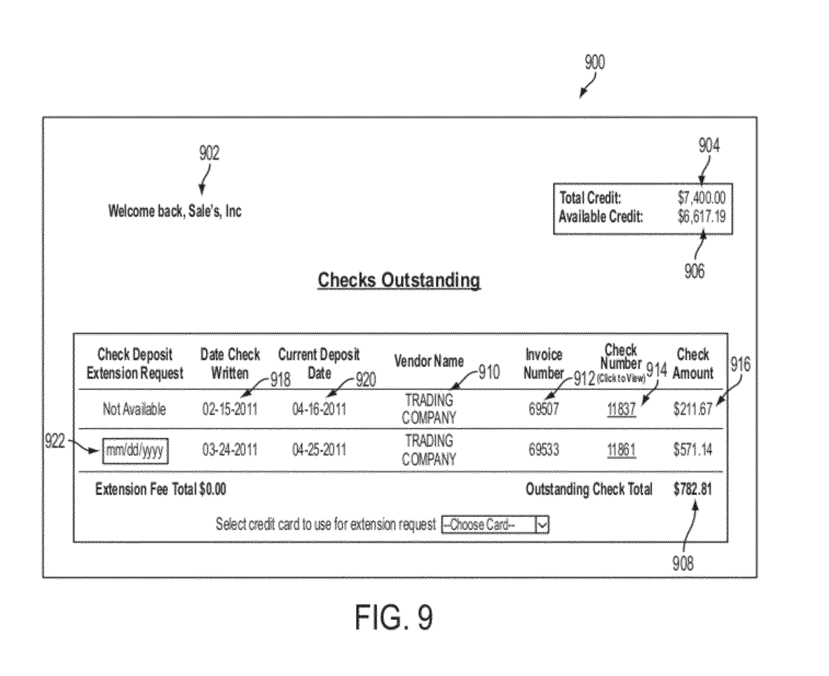

In some embodiments, the customer may access the COD provider (via an interface) to extend the hold on the COD payment. FIG. 9 illustrates an example interface 900 provided to a customer by the COD provider, wherein the interface 900 shown in FIG. 9 displays the customer's outstanding COD payments. The interface 900 also displays customer data such as the customer name 902, the customer's total credit 904, the customer's available credit 906, and an outstanding check total 908. The interface also includes COD payment data for each COD payment, wherein the payment data includes the vendor name 910, invoice number 912, check number 914, check amount 916, the date 918 the check was written, the scheduled deposit date 920, and (if available) an option 922 for extending the scheduled deposit date. Using the interface 900, the customer may enter a date to extend the scheduled date for processing or depositing a COD payment. Once the hold on the customer's COD payment has expired, the COD provider processes the COD payment in step 208, and may fund any remaining invoice amount to the vendor.

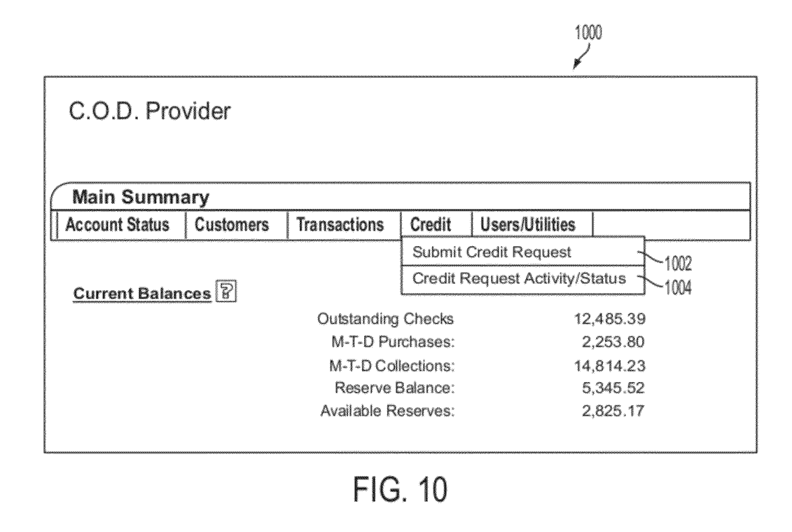

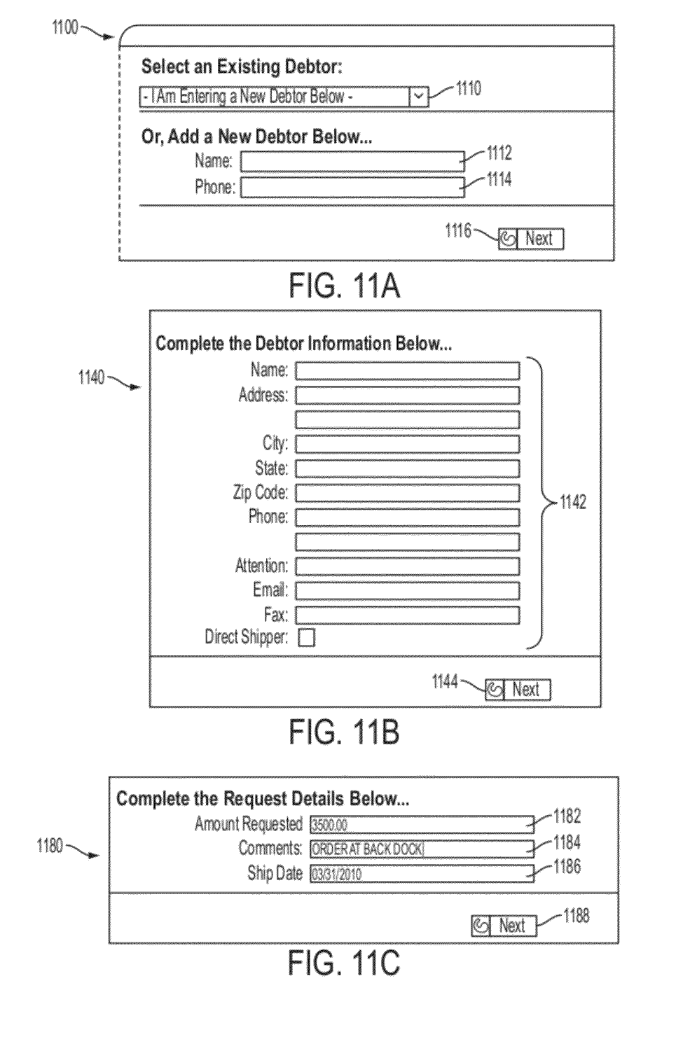

In some embodiments, the COD provider may provide various interfaces to allow a vendor or customer to access their respective accounts. For example, a vendor may access an interface such as that shown in FIG. 10 to request a line of credit for a customer. FIG. 10 illustrates an example interface 1000 wherein a vendor may access the COD provider to request a credit line for a customer by selecting the “Submit Credit Request” tab 1002. After selecting the submit credit request tab 1002, the COD provider presents the interfaces 1100, 1140, and 1180 shown in FIGS. 11A-11C, respectively. The interface 1100 in FIG. 11A prompts the vendor to select an existing debtor (i.e., customer) from a drop-down menu 1110, or enter a new debtor in the name field 1112 and phone number field 1114. After selecting the next icon 1116, the COD provider stores the debtor information in a database and presents the interface 1140 shown in FIG. 11B. The interface 1140 prompts the vendor to enter the customer's information in the debtor fields 1142 shown in FIG. 11B, and to select the next icon 1144. The COD provider then stores the customer's information in a database and presents the interface 1180 provided in FIG. 11C. The interface 1180 prompts the vendor to enter the amount requested 1182, any comments 1184, and a shipping date 1186 and to submit the credit request by selecting the next icon 1188. The COD provider then stores the data entered via the interface 1180 in a database. It should be appreciated that, in some embodiments, the credit request may be performed by the customer, rather than by the vendor.

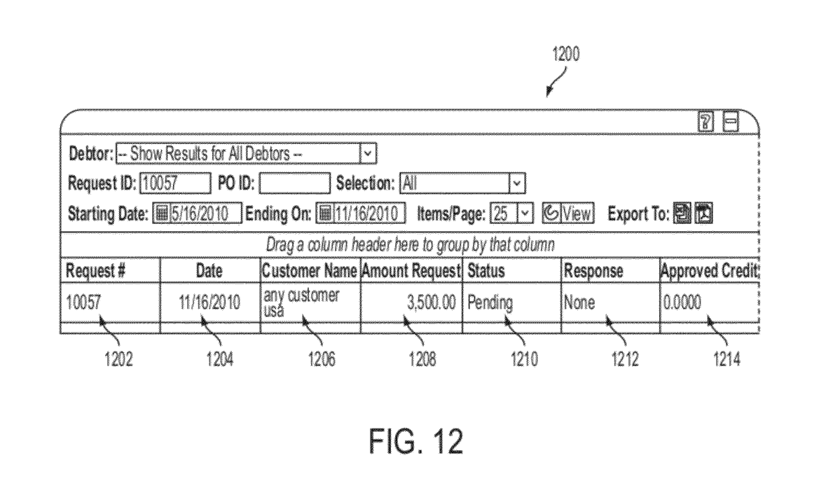

Once stored in the database by the COD provider, the credit request (and any other previous requests) may be viewed by selecting the “Credit Request Activity/Status” tab 1004 shown in FIG. 10. FIG. 12 illustrates an example interface 1200 for viewing one or more credit requests, wherein the interface 1200 is accessed by selecting the tab 1004 in FIG. 10. The interface 1200 may access a database to provide, for example: a request ID 1202, request date 1204, customer name 1206, request amount 1208, request status 1210, a response 1212 (if provided), and an amount of approved credit 1214.

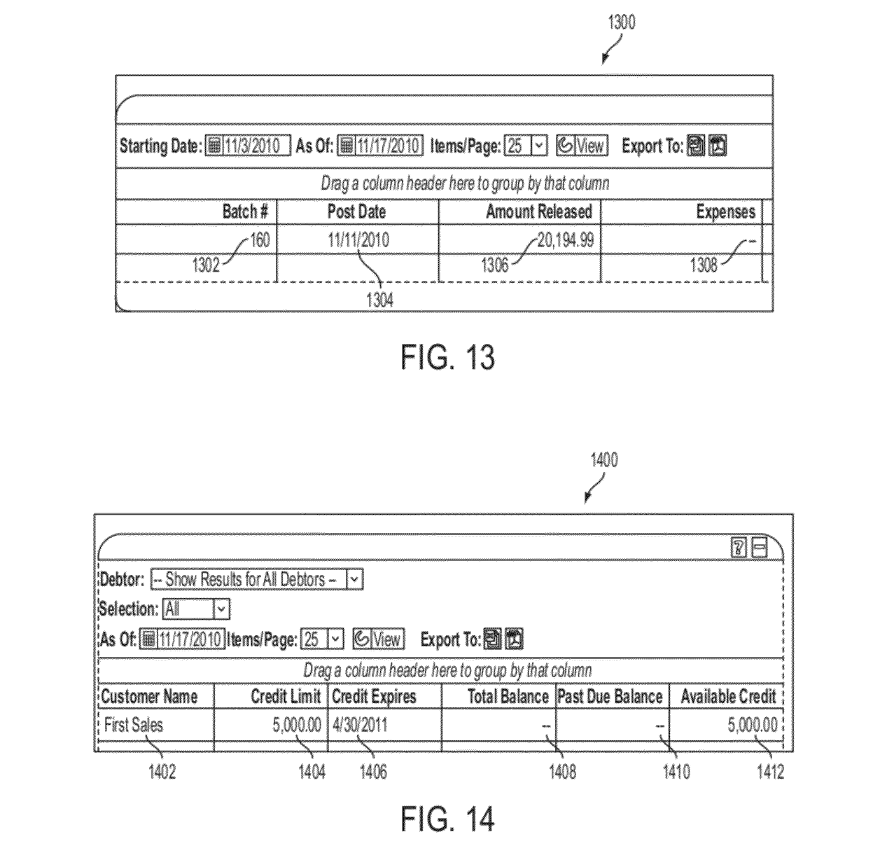

In some embodiments, the COD provider may also provide an interface to allow a vendor to check the status of funds. For example, the vendor may access the COD provider through an interface 1300, such as that shown in FIG. 13, to view processed reserve disbursements. The interface 1300 may be viewed, in some embodiments, by selecting a “Transactions” tab (such as that shown in FIG. 8A) then selecting a “Processed Reserve Disbursements” sub-tab, or link (not shown). In the example interface 1300 shown in FIG. 13, the COD provider retrieves data from a database and displays it to the vendor. This data may include, for example: a batch number 1302, posting date 1304, amount released 1306, and any expenses 1308. The example reserve disbursement illustrated in FIG. 13 shows that the COD provider transferred funds in the amount of $20,194.99 to the vendor's bank account on Nov. 11, 2010.

FIG. 14 illustrates an example embodiment of an interface 1400 for accessing the COD provider, wherein the interface 1400 is provided to allow a vendor or customer to see if the customer has been approved for a line of credit. In some embodiments, the interface 1400 may be accessed by selecting a “Customers” tab (such as that shown in FIG. 8A) and selecting a “Customer Availability” sub-tab, or link (not shown). The interface 1400 presents customers for which a line of credit has been requested, and shows the customer name 1402, credit limit 1404, credit expiration date 1406, total balance 1408, past due balance 1410, and available credit 1412, which is retrieved from a database of a specially programmed computer of the COD provider. In some embodiments, this data may be viewed by the customer. In the example embodiment illustrated in FIG. 14, the COD provider allocated a $5,000.00 line of credit to a customer due to expire on Apr. 30, 2011.

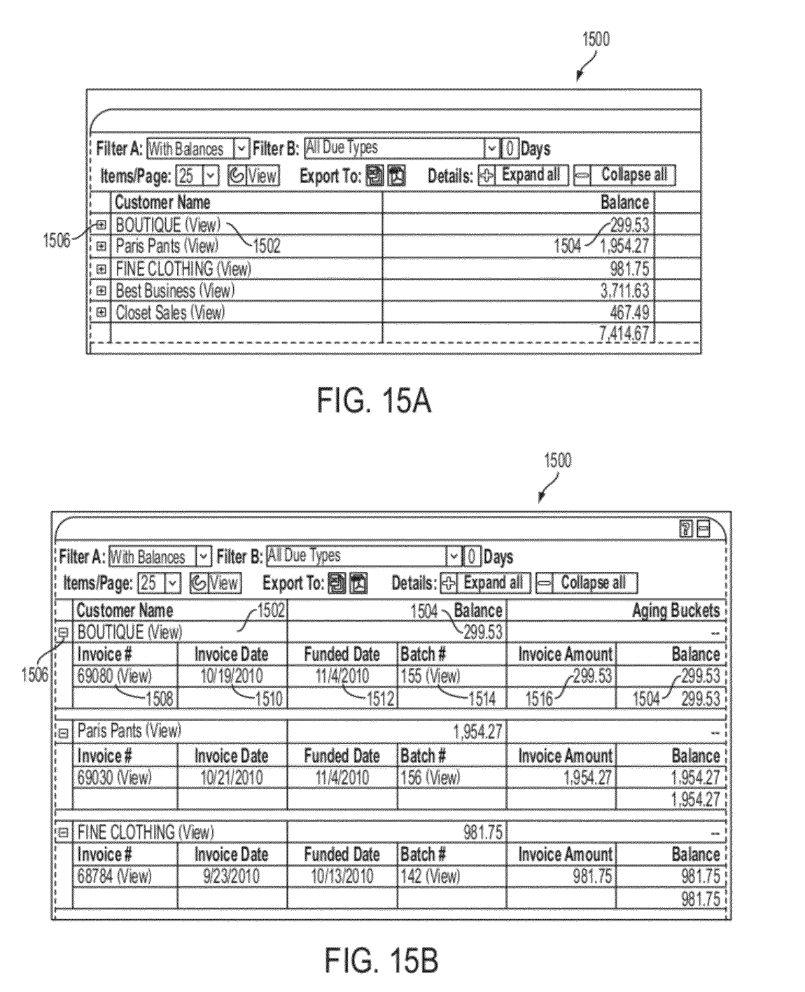

FIGS. 15A and 15B illustrate an example embodiment of an interface 1500 for accessing the COD provider, wherein the interface 1500 is provided to illustrate customer balances. In some embodiments, the interface 1500 may be accessed by selecting a “Client Aging” link (such as that shown in FIG. 8A). In the interface 1500, customers 1502 having outstanding balances are shown along with each customer's respective outstanding balance 1504. The content of each customer 1502 may be expanded by selecting a expansion tab 1506. The expanded view of the interface 1500 is shown in FIG. 15B, wherein the expanded view provides additional details for each customer 1502. For example, as shown in FIG. 15B, the expanded view also illustrates each customer's invoice number 1508, invoice date 1510, funded date 1512, batch number 1514, invoice amount 1516, and the remaining balance 1504. The data provided in the interface 1500 shown in FIGS. 15A and 15B (and that shown in any other interfaces provided herein) is stored in and retrieved from a database of a specially programmed computer by the COD provider. In some embodiments, some of this data may accessible to a customer.

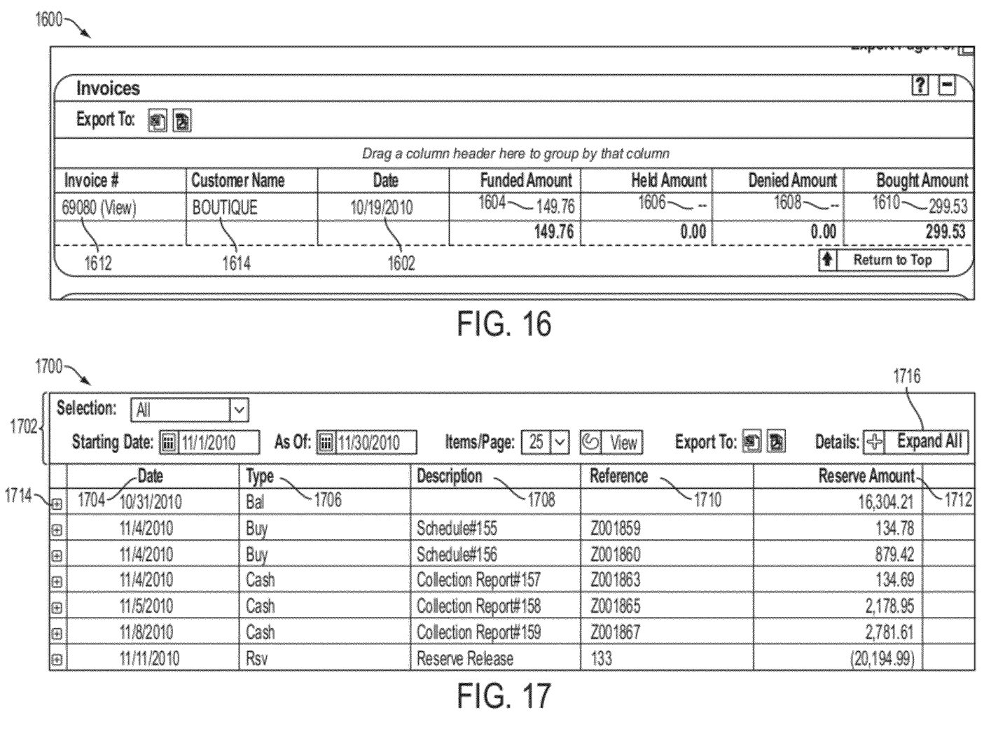

In accordance with the embodiments illustrated in FIGS. 15A and 15B, additional data may be displayed by selecting any of the items provided in the expanded view shown in FIG. 15B. For example, if the vendor selects the batch number 1514, the COD provider displays the interface 1600 provided in FIG. 16. From the interface 1600, the vendor is able to view additional data such as, for example, the date 1602 a COD payment was transferred, the amount 1604 funded to the vendor upon submission of the batch, any amount that was held 1606, any amount denied 1608, and the bought amount 1610, wherein the bought amount 1610 is the cost of the merchandise plus shipping (i.e., does not include a COD provider fee). In the example interface 1600 shown in FIG. 16, the invoice 1612 for the customer 1614 was submitted to the customer for payment in the amount of $299.53 plus the COD provider fee. The COD payment was received by the COD provider on Oct. 19, 2010, and funds in the amount of $149.76 were transferred to the vendor upon receipt of the COD payment.

FIG. 17 illustrates yet another example embodiment of an interface 1700 for accessing the COD provider. In the embodiment illustrated in FIG. 17, a vendor is able to access their vendor account to view account activity, wherein the interface 1700 may be accessed by selecting a “Reserve Activity” link (such as that shown in FIG. 8A). As provided with most interfaces, the interface 1700 includes a menu 1702 for filtering or sorting the data provided therein. The interface 1700 provides the date 1704 of a transaction, the type 1706 of transaction, a description 1708, a reference number 1710, and a reserve amount 1712. More detail may be displayed by selecting an expansion tab 1714 or by selecting the “Expand All” icon 1716. The transaction type 1706 and description 1708 may correspond to various transactions such as, for example, a balance forward from the prior month (i.e., Type: Bal), a scheduled transfer of funds from the COD provider for a new batch (i.e., Type: Buy; Description: Schedule), a report of COD payments deposited or processed by the COD provider (i.e., Type: Cash; Description: Collection Report), and an amount of funds released to a vendor (i.e., Type: Rsv; Description: Reserve Release).

It should be appreciated that various aspects of the disclosed COD process may be altered, or possibly omitted, without departing from the scope of the present disclosure as defined by the claims below. For example, in some embodiments, some or all of the funds may not be transferred to the vendor (or may be transferred after a delay) if certain conditions occur, wherein such conditions may include, for example, a reported dispute between the customer and vendor. Additionally, in certain embodiments, a portion of the remaining funds (or none of the remaining funds) may be transferred to the vendor in step 208 if the customer provides insufficient COD payment. In such cases, the COD provider may charge a credit card associated with the customer's account or pursue some other means for obtaining proper COD payment.

What is claimed is:

1. A system for implementing an automated method for processing a payment received upon a customer's receipt of merchandise delivered from a vendor, the system comprising:
a server operable to provide a vendor interface for receiving vendor data, a customer interface for receiving customer data, and a payment interface for receiving payment data;
a data network operable to connect the server to one or more remote computers operable to access at least one of the vendor interface, the customer interface, or the payment interface; and
a database operable to store at least one of the vendor data, the customer data, or the payment data,
wherein the server is further operable to store the vendor data received from the vendor interface in the database and generate a vendor account,
wherein the server is further operable to store the customer data received from the customer interface in the database and generate a customer account,
wherein the server is further operable to store the payment data received from the payment interface in the database, associate the payment data with at least one of the vendor account or customer account, and transfer funds to a bank account of the vendor, and
wherein the server is further operable to process the payment after a predetermined amount of time.

2. The system as set forth in claim 1, wherein the payment interface comprises a program stored on a computer operable to read a scanned image of the payment and generate the payment data.

3. The system as set forth in claim 1, wherein the payment data comprises at least one of an invoice amount, invoice data, customer data, vendor data, a payment amount, a fee amount, payment date, a customer account number, a vendor account number, a check number, a routing number, a bank account number, a credit card number, a security code, a credit card expiration date, electronic signature data, a scanned image of the payment, a scan date, and a processing date.

4. The system as set forth in claim 1, wherein the server is further operable to transfer additional funds to the bank account of the vendor upon processing the payment.

5. The system as set forth in claim 1, wherein the payment interface receives the payment data from a remote computer operated by the vendor.

6. The system as set forth in claim 1, wherein the payment interface receives the payment data from a remote computer operated by a carrier delivering the merchandise to the customer.

7. The system as set forth in claim 1, wherein the server is further operable to provide a schedule interface for receiving a date for calculating the predetermined amount of time.

8. The system as set forth in claim 7, wherein the schedule interface receives the date from a remote computer operated by the customer.

9. The system as set forth in claim 1, wherein the vendor data comprises at least one of a corporate name, trade name, tax information, address data, a phone number, a fax number, an email address, a contact name, business type, date of establishment, company website, revenue data, ownership data, company policy data, bank account data, electronic money transfer instructions, and vendor account data.

10. The system as set forth in claim 1, wherein the customer data comprises at least one of store data, principal data, credit card data, bank data, and customer account data.

11. A computer-implemented method for processing a collect on delivery transaction between a vendor providing a product and a customer receiving the product, the method comprising:
generating a vendor interface for receiving vendor data from a remote computer operable to access the vendor interface;
communicating received vendor data to a server over a data network;
storing the vendor data in a database;
generating a vendor account using the vendor data;
generating a customer interface for receiving customer data from a remote computer operable to access the customer interface;
communicating received customer data to the server over the data network;
storing the customer data in the database;
generating a customer account using the customer data;
generating a payment interface for receiving payment data from a remote computer operable to access the payment interface;
communicating received payment data to the server over the data network;
storing the payment data in the database;
associating the payment data with at least one of the vendor account or customer account;
transferring funds to a bank account of the vendor upon associating the payment data with at least one of the vendor account or customer account; and
processing the payment data after a predetermined amount of time to receive funds from the customer.

12. The method as set forth in claim 11, wherein the payment interface comprises a program stored on a computer operable to read a scanned image of the payment and generate the payment data.

13. The method as set forth in claim 11, wherein the payment data comprises at least one of an invoice amount, invoice data, customer data, vendor data, a payment amount, a fee amount, payment date, a customer account number, a vendor account number, a check number, a routing number, a bank account number, a credit card number, a security code, a credit card expiration date, electronic signature data, a scanned image of the payment, a scan date, and a processing date.

14. The method as set forth in claim 11, further comprising transferring additional funds to the bank account of the vendor upon processing the payment data.

15. The method as set forth in claim 11, wherein the payment interface receives the payment data from a remote computer operated by the vendor.

16. The method as set forth in claim 11, wherein the payment interface receives the payment data from a remote computer operated by a carrier delivering the product to the customer.

17. The method as set forth in claim 11, further comprising generating a schedule interface for receiving a date for calculating the predetermined amount of time.

18. The method as set forth in claim 17, wherein the schedule interface receives the date from a remote computer operated by the customer.

19. The method as set forth in claim 11, wherein the vendor data comprises at least one of a corporate name, trade name, tax information, address data, a phone number, a fax number, an email address, a contact name, business type, date of establishment, company website, revenue data, ownership data, company policy data, bank account data, electronic money transfer instructions, and vendor account data.

20. The method as set forth in claim 11, wherein the customer data comprises at least one of store data, principal data, credit card data, bank data, and customer account data.
